(19) United States
(12) Patent Application Publication
(10) Pub. No.: US 2026/0321583 A1
(43) Pub. Date: Oct. 15, 2026

(54) MESH-STRUCTURED LITHIUM ELECTRODE AND LITHIUM SECONDARY BATTERY COMPRISING SAME

(71) Applicant: SILI ENERGY INC., Daejeon (KR)

(72) Inventor: Kyoung Jin JEONG, Seoul (KR)

(21) Appl. No.: 19/688,448

(22) Filed: May 26, 2026

Related U.S. Application Data
(63) Continuation of application No. PCT/KR2024/009265, filed on Jul. 2, 2024.

(30) Foreign Application Priority Data
Nov. 30, 2023 (KR) 10-2023-0171467

(51) Int. Cl. H01M 4/134; H01M 4/02; H01M 4/04; H01M 4/1395; H01M 4/66; H01M 4/74; H01M 10/052; H01M 10/0562

(52) U.S. Cl. CPC H01M 4/134; H01M 4/045; H01M 4/1395; H01M 4/661; H01M 4/663; H01M 4/667; H01M 4/747; H01M 10/052; H01M 10/0562; H01M 2004/021; H01M 2300/0068; H01M 2300/008

(57) ABSTRACT

Provided is a mesh-type lithium electrode manufactured by forming a structure using a fiber bundle composed of a plurality of fibers and forming a conductive layer on a surface thereof. Such a mesh-type lithium electrode has the effect of uniformly dispersing the distribution of an electric field applied during charging and discharging of a battery, thereby preventing the formation of dendrites and excess lithium at a negative electrode made of lithium metal during the operation of the battery.

### TECHNICAL FIELD

The present invention relates to a mesh-structured lithium electrode and a lithium secondary battery including the same.

### BACKGROUND ART

Most existing lithium metal electrode technologies for lithium secondary batteries use lithium foil. However, during battery charging and discharging, the lithium foil electrode is used non-uniformly due to the uneven behavior of lithium ions. Consequently, lithium is gradually depleted and lithium dendrites are formed, which can physically damage the separator and cause short circuits between a positive electrode and a negative electrode, rendering the battery unusable; furthermore, when a large short-circuit current flows instantaneously, a massive amount of heat is generated, posing a risk of fire and explosion.

Research has been conducted to physically suppress the formation of dendrites by applying a ceramic or polymer coating film to suppress the formation of dendrites on lithium foil electrodes. Although such a coating film has the effect of suppressing dendrites immediately after application, there is a problem in that the coating film is damaged during battery use, or the dendrites grow slowly until the protective function of the coating film is no longer active, and then grow explosively, thereby reproducing the above disadvantages.

As another measure to suppress lithium dendrites, methods for suppressing dendrite growth by inserting a mesh made of Cu or stainless steel (SUS) have been studied. However, these methods have disadvantages such as increased cell thickness and volume, leading to a decrease in energy density, as well as the problem of a significant increase in manufacturing costs.

The disadvantages of the lithium foil electrodes described above are characterized by being exacerbated as the electrode surface becomes rougher, high-rate charging and discharging are sustained, and the distance between positive electrode and negative electrode increases.

Meanwhile, due to the limited market size for lithium foil, large domestic corporations are not entering this manufacturing sector, and also small and medium-sized enterprises (SMEs) also avoid entry because the manufacturing process is difficult, requiring the environment to be strictly maintained under an inert atmosphere from lithium purification to rolling.

Accordingly, the present invention aims to solve the above problems by identifying the dendrite formation mechanism in a lithium metal electrode from the distribution of the electric field. Specifically, the present invention is directed to providing a method of forming a lithium electrode from a low-purity lithium source using a structure to microscopically induce and cancel out the electric field generated from the electrode, thereby uniformly dispersing the electric field macroscopically to suppress the formation of dendrites.

### DESCRIPTION OF INVENTION

### Technical Problem

To solve the above-mentioned problems, the present invention is directed to providing a mesh-structured lithium electrode and a lithium secondary battery including the same.

### Technical Solution

To solve the above-mentioned problems, the present invention provides a lithium electrode, which includes: a fiber bundle composed of a plurality of fibers; a structure having a mesh form composed of the fiber bundle; a conductive layer formed on the structure; and a lithium layer formed on the conductive layer.

In the lithium electrode, openings, which are empty spaces between the fiber bundles constituting the structure, may be formed at a density of 10 to 1,000/inch².

The fiber may be glass fiber.

A shape of the opening may be circular or polygonal.

The conductive layer may be composed of any one or a mixture of two or more selected from the group consisting of metal materials such as magnesium (Mg), a magnesium-calcium alloy (Mg—Ca alloy), copper (Cu), silver (Ag), tin (Sn), and SUS; or the group consisting of carbon materials such as carbon-based conductive materials, graphite, graphene, and carbon nanotubes (CNTs).

The conductive layer may be in a form that surrounds the structure.

The lithium layer may be in a form that surrounds the conductive layer.

A sum of thicknesses of the conductive layer and the lithium layer may range from 1 to 100 μm.

The present invention provides a method of manufacturing the lithium electrode. Specifically, the method may include a step (A) of forming a fiber bundle using a plurality of fibers; a step (B) of forming a structure using the fiber bundle; a step (C) of forming a conductive layer on a surface of the structure; and a step (D) of forming a lithium layer on a surface of the conductive layer.

The lithium layer in the step (D) may be electrochemically formed on the surface of the conductive layer.

In addition, the present invention provides a lithium secondary battery including the lithium electrode.

The lithium secondary may include any one or more solid electrolytes selected from LSPS(Li₁₀SnP₂S₁₂), LGPS(Li₁₀GeP₂S₁₂), and LPSCl(Li₆PS₅Cl).

The lithium secondary battery may include a composite of the lithium electrode and a solid electrolyte.

The lithium secondary battery may include any one selected from LCO (LiCoO₂), NCM (LiNiₓCo_{y}Mn_{z}O₂, x+y+z=1), LFP (LiFePO₄), and lithium polysulfide (Li₂Sₓ, 0<x≤9) as a positive electrode.

### Advantageous Effects

A lithium electrode according to the present invention has the effect of improving the lifetime of a lithium electrode and furthermore, the overall lifetime of a battery, by minimizing the distribution of an electric field generated during the charging and discharging of a rechargeable battery through a mesh structure to uniformly regulate the non-uniform oxidation-reduction tendency of lithium between the center and the edges of the electrode.

### DESCRIPTION OF DRAWINGS

FIG. 1 is a simulation result showing an electric field formed during the charging of a lithium secondary battery.

FIG. 2 is a photograph of a structure formed in a preparation example of the present invention.

FIG. 3 is a photograph of a conductive layer made of graphite formed on the structure.

FIG. 4 is a photograph of a conductive layer made of silver (Ag) formed on the structure.

FIG. 5 is a photograph of a conductive layer made of silver (Ag) formed on the structure.

FIG. 6 shows a photograph showing a surface of a conductive layer made of silver (Ag) and a photograph showing the formation of dendrites and excess lithium during the formation of a lithium layer in a beaker cell using the conductive layer as a working electrode.

FIG. 7 is a photograph showing a manufacturing process of an embodiment provided in the present invention.

FIG. 8 is a photograph of an embodiment provided in the present invention.

FIG. 9 is a graph showing the results of measuring specific capacity according to the C-rate of a battery

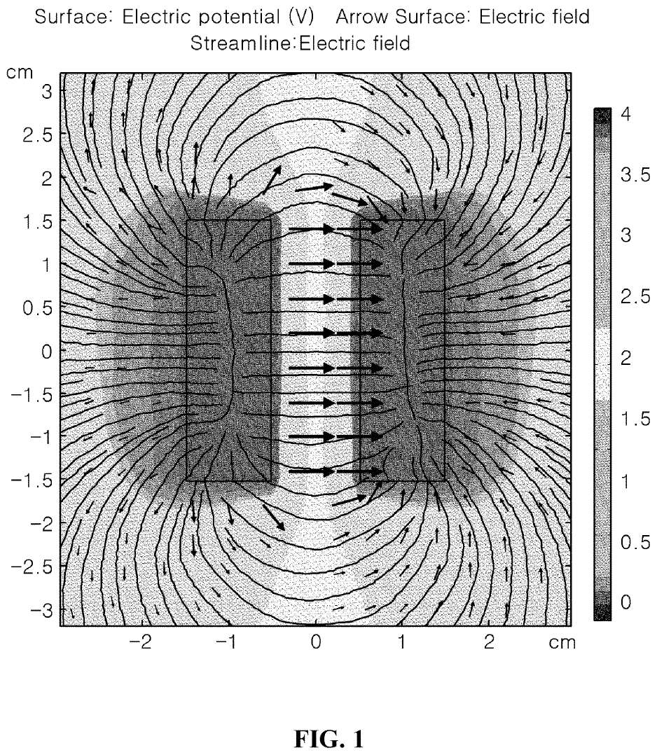

### MODES OF THE INVENTION

Hereinafter, the lithium electrode according to the present invention and the lithium secondary battery including the lithium electrode will be described in detail. The accompanying drawings presented below are provided as examples so that the spirit of the present invention can be sufficiently conveyed to those skilled in the art. Therefore, the present invention is not limited to the drawings presented below and may be embodied in other forms; furthermore, the drawings presented below may be exaggerated for clarity in illustrating the spirit of the present invention. Unless otherwise defined, all technical and scientific terms used herein have the same meaning as commonly understood by one of ordinary skill in the art to which this invention belongs. In the following description and the accompanying drawings, descriptions of well-known functions and configurations that may unnecessarily obscure the subject matter of the present invention will be omitted.

To solve the above-mentioned problems, the present invention provides a lithium electrode, which includes: a fiber bundle composed of a plurality of fibers; a structure having a mesh form composed of the fiber bundle; a conductive layer formed on the structure; and a lithium layer formed on the conductive material.

In the lithium electrode, openings, which are empty spaces between the fiber bundles constituting the structure, may be formed at a density of 10 to 1,000/inch². By configuring the structure in a mesh form, the electric field generated along the surface of any one fiber bundle microscopically offsets the electric field generated along the surface of another intersecting fiber bundle, and thus from a macroscopic perspective, the distribution of the electric field generated from the lithium electrode can become uniform.

The fiber may be glass fiber. Glass fiber is a material with excellent thermal insulation and chemical resistance. As an insulator, the glass fiber does not participate in electrochemical reactions within the lithium secondary battery, and due to being lightweight and robust, it has a low probability of structural deformation caused by various side reactions or external forces within the battery. The glass fiber is a commonly used chemical fiber and may be any one selected from the group consisting of Type A (alkali-resistant), Type C (chemical-resistant), Type E (for electrical components), and Type S (for high strength), which are classified according to the composition of raw materials.

More specifically, since the glass fiber in the present invention is highly likely to be directly exposed to various chemicals such as acids, bases, and organic electrolytes, it is preferable to use a C-type glass fiber with excellent chemical resistance.

The above glass fiber may be produced by drawing out raw materials melted at a high temperature into filaments with a diameter of 3 to 20 μm, and these filaments are then surface-treated with a binder and bundled into strands consisting of 50 to 2,000 filaments.

In the present invention, the fiber may use the strand directly or a yarn formed by twisting and winding the strand or a roving formed by winding the strand without twisting. In this case, it is preferable to use roving, which is advantageous for forming because it has no twisting and has excellent mechanical strength.

The fiber bundle is a collection of fibers that are aligned in a certain direction, and one fiber bundle may consist of 10 to 1,000 fibers. By forming a structure by weaving a plurality of fibers into a fiber bundle in this way, the physical durability of the structure can be significantly increased because no damage occurs even when the shape of the structure is deformed by an external force.

A shape of the opening may be circular or polygonal. When the opening is circular or polygonal such as pentagonal or higher, there is an advantage that the distribution of the microscopic electric field can become more uniform, but there is a problem that manufacturing the structure is difficult, which may increase costs and decrease productivity. Therefore, it is desirable to have a triangular or square opening that can control the distribution of the electric field while being cost-effective and highly productive.

In addition, the present invention may provide a form in which the outer surface of the fiber bundle is wrapped with silver nanowires or coated with silver nanowires. Since the fiber bundle consists of non-conductive glass fibers, it may be difficult to coat a conductive layer on the surface. Therefore, a method of coating a conductive layer only with silver nanowires may be used, and in cases where the conductive layer is composed of silver (Ag), there is an advantage in that the conductive layer can be more easily and uniformly formed using the silver nanowires as a nucleation medium for silver (Ag) particles. The diameter and length of the silver nanowires are not particularly limited, but for example, an average diameter may range from 20 to 100 nm and an average length may range from 1 to 500 μm.

The conductive layer may be composed of any one or a mixture of two or more selected from the group consisting of metal materials such as silver (Ag), tin (Sn), copper (Cu), silicon (Si), aluminum (Al), germanium (Ge), lead (Pb), bismuth (Bi), antimony (Sb), a silicon alloy (Si-Y), and SUS; or the group consisting of carbon materials such as carbon-based conductive materials, graphite, graphene, and carbon nanotubes (CNTs). In this case, Y constituting the silicon alloy (Si-Y) is one or more selected from the group consisting of alkali metals, alkaline earth metals, Group 13 elements, Group 14 elements, transition metals, and rare earth elements, excluding silicon (Si), and specific examples include magnesium (Mg), calcium (Ca), strontium (Sr), barium (Ba), radium (Ra), scandium (Sc), yttrium (Y), titanium (Ti), zirconium (Zr), hafnium (Hf), rutherfordium (Rf), vanadium (V), niobium (Nb), tantalum (Ta), dubnium (Db), chromium (Cr), molybdenum (Mo), tungsten (W), seaborgium (Sg), technetium (Tc), rhenium (Re), bohrium (Bh), iron (Fe), lead (Pb), ruthenium (Ru), osmium (Os), hassium (Hs), rhodium (Rh), and iridium (Ir), palladium (Pd), platinum (Pt), copper (Cu), silver (Ag), gold (Au), zinc (Zn), cadmium (Cd), boron (B), aluminum (Al), gallium (Ga), tin (Sn), indium (In), germanium (Ge), phosphorus (P), arsenic (As), antimony (Sb), bismuth (Bi), sulfur(S), selenium (Se), or tellurium (Te).

When the conductive layer is selected from the group consisting of metal materials, it exhibits excellent electronic conductivity. Furthermore, due to the low overpotential required for lithium nucleation and low resistance, there is an advantage in that the electrochemical formation of the lithium layer during the manufacturing process of the lithium electrode proceeds uniformly and rapidly. In particular, when using silver (Ag), silicon (Si), tin (Sn), aluminum (Al), germanium (Ge), lead (Pb), bismuth (Bi), antimony (Sb), or a silicon alloy (Si-Y), a certain amount of lithium forms an alloy without being deposited on the surface, thereby significantly increasing the lithium storage capacity. However, since the metal material group has a narrow electrochemical window, when the conductive layer is directly exposed to the electrolyte within the battery, metal cations may be generated, which can adversely affect the capacity and lifetime characteristics of the battery. Therefore, when using the metal material group for a conductive layer, it is necessary to perform control so that the surface of the structure is completely covered, and it is most desirable to uniformly form a conductive layer while preventing the fiber bundles from being dispersed using nanowires and the like.

In addition, when the conductive layer is selected from the group consisting of carbon materials, the electronic conductivity is lower than that of metal, and the overpotential required for nucleation is higher and the resistance is greater, so the electrochemical deposition of lithium may proceed somewhat slowly. However, the carbon material group has a high specific surface area, and carbon combined with lithium (such as LiC₆) has excellent stability compared to lithium metal, which can have a positive effect on the capacity and lifetime characteristics of the battery.

The conductive layer may be in a form that surrounds the structure. Preferably, in cases where it is desirable for the conductive layer to surround the structure with a uniform thickness and the conductive layer is not formed evenly on the surface of the structure, in particular, in cases where the conductive layer is formed so coarsely that the surface of the structure is exposed, the electronic conductivity of the structure is very low, making it impossible to deposit lithium, and lithium is deposited unevenly only in the parts where the conductive layer is formed, thereby promoting the generation of excess lithium that does not participate in charging and discharging at all and reduces the active area of the electrode. Therefore, in order to preferably implement the present invention, it is indispensable that the conductive layer be formed to completely cover the surface of the structure.

In addition, the present invention may further include a separate layer between the conductive layer and the lithium layer. Such a layer is intended to increase the contact force between the conductive layer and the lithium layer or to reduce interfacial resistance, and may be composed of carbon fiber, carbon foam, metal foam, metal wire, or metal foil. In this case, the metal constituting the layer may be one or more selected from silver (Ag), gold (Au), copper (Cu), calcium (Ca), zinc (Zn), aluminum (Al), tin (Sn), and nickel (Ni).

The lithium layer may be in a form that surrounds the conductive layer. The lithium layer is electrochemically deposited on the conductive layer and may perform the same role as a conventionally used lithium metal electrode, such as the storage and release of lithium.

The sum of thicknesses of the conductive layer and the lithium layer may range from 5 to 120 μm.

The conductive layer serves as an electrode, a medium, and a catalyst when forming the lithium layer, and also serves as a current collector in the electrode. Although there is no particular limitation on its thickness, the thickness may range from, for example, 1 to 20 μm. In addition to serving as a medium for forming a lithium layer as described above, the conductive layer also functions as a current collector provided in an electrode for a conventional lithium secondary battery. When the thickness of the conductive layer is less than 1 μm, it may fail to sufficiently cover the surface of the structure, which may promote the generation of excess lithium as described above. Conversely, when the thickness of the conductive layer exceeds 20 μm, the thickness of the lithium layer must be adjusted to control the distribution of the electric field, thereby relatively reducing the thickness of the lithium layer and consequently decreasing the lithium storage capacity of the electrode. Therefore, in order to optimize the convenience of forming the lithium layer and the lithium storage capacity of the electrode, it is desirable for the conductive layer to be formed on the structure with a thickness of 1 to 10 μm.

The lithium layer serves as a negative electrode active material that stores and releases lithium during the charging and discharging of the battery. As the lithium layer is formed thicker on the conductive layer, the depletion of the lithium source within the battery can be prevented, and the surface area where lithium is exposed to the electrolyte increases, thereby improving the power density and energy density of the battery. However, when the lithium layer is formed excessively thick, for example, with a thickness of 100 μm or more, it is not desirable because it may become difficult to maintain a uniform distribution of the electric field in the parts where the fiber bundles overlap in different directions (the intersection parts of the fiber bundles in the mesh form). In addition, as the charging and discharging of the lithium secondary battery progresses, excess lithium is formed and the lithium source may be depleted. When the thickness of the lithium layer is less than 5 μm, it is difficult to replenish this depletion, which may reduce the battery lifetime and reduce the surface area where lithium is exposed to the electrolyte, thereby lowering the power density and energy density of the battery. Therefore, the thickness of the lithium layer ranges from preferably 5 to 100 μm or 10 to 50 μm.

The present invention provides a method of manufacturing the lithium electrode. Specifically, the method may include a step (A) of forming a fiber bundle using a plurality of fibers; a step (B) forming a structure using the fiber bundle; a step (C) forming a conductive layer on a surface of the structure; and a step (D) forming a lithium layer on a surface of the conductive layer.

In the step (C), a method of forming the conductive layer is not particularly limited, and for example, dip coating using metal inks and pastes; printing methods such as screen printing, inkjet printing, and roll printing; plating methods using electrolytic or electroless processes; thermal evaporation; physical vapor deposition; sputtering; and spin coating may be used.

The lithium layer in the step (D) may be electrochemically formed on the surface of a conductive layer. For example, the lithium layer may be configured as a working electrode using the structure having the conductive layer formed on its surface, and may be configured as a counter electrode using lithium metal, lithium carbonate (Li₂CO₃), lithium hydroxide (LiOH), lithium scrap, or scrap consisting of black powder obtained by separating and crushing used rechargeable batteries. Next, lithium ions can be extracted and controlled from the counter electrode and moved onto the structure having the conductive layer formed thereon, and then the lithium ions can be reduced on the conductive layer of the structure to form a lithium layer.

Furthermore, the lithium electrode of the present invention may be provided in a composite form with lithium metal electrodes, silicon electrodes, and graphite-silicon composite electrodes conventionally used in the art. As described above, the lithium electrode of the present invention has the effect of inducing a uniform distribution of the electric field from a macroscopic perspective by forming a mesh structure and thus can be used with electrodes for which uniform reduction and deposition of lithium, which were previously difficult, to improve stability. In addition, the lithium electrode can significantly improve the performance of a lithium secondary battery by simultaneously performing the role of an electrode that directly stores or releases lithium ions, in addition to the auxiliary aspect of enhancing the stability of the electrode as described above.

In addition, the present invention provides a lithium secondary battery including the lithium electrode.

The lithium secondary battery may include one or more solid electrolytes selected from LSPS(Li₁₀SnP₂S₁₂), LGPS(Li₁₀GeP₂S₁₂), and LPSCl(Li₆PS₅Cl).

The lithium secondary battery may include a composite of the lithium electrode and the solid electrolyte. Here, the composite refers to a form in which the lithium electrode is surrounded by a solid electrolyte. In the case of conventional lithium secondary batteries using solid electrolytes, the solid electrolyte is located between the positive electrode and the negative electrode, which creates a gap between the solid-solid interfaces, making it difficult to transport lithium ions and resulting in a limitation of very high interfacial resistance. However, by combining them in this way, the interfacial contact is improved, which can significantly enhance the performance of the battery.

The lithium secondary battery may include, as a positive electrode, any one selected from LCO (LiCoO₂), NCM (LiNiₓCo_{y}Mn_{z}O₂, x+y+z=1), LFP (LiFePO₄), and lithium polysulfide (Li₂Sₓ, 0<x≤9).

Hereinafter, a lithium electrode having a mesh structure according to the present invention and a lithium secondary battery including the same will be described in more detail through examples. However, the following examples are merely a reference for describing the present invention in detail, and the present invention is not limited thereto and may be implemented in various forms.

In addition, unless otherwise defined, all technical and scientific terms have the same meanings as commonly understood by one of ordinary skill in the art to which the present invention belongs. The terms used herein are merely for the purpose of effectively describing particular examples and are not intended to limit the present invention. In addition, unless otherwise specified in the specification, the unit of additives may be weight percent.

### PREPARATION EXAMPLE

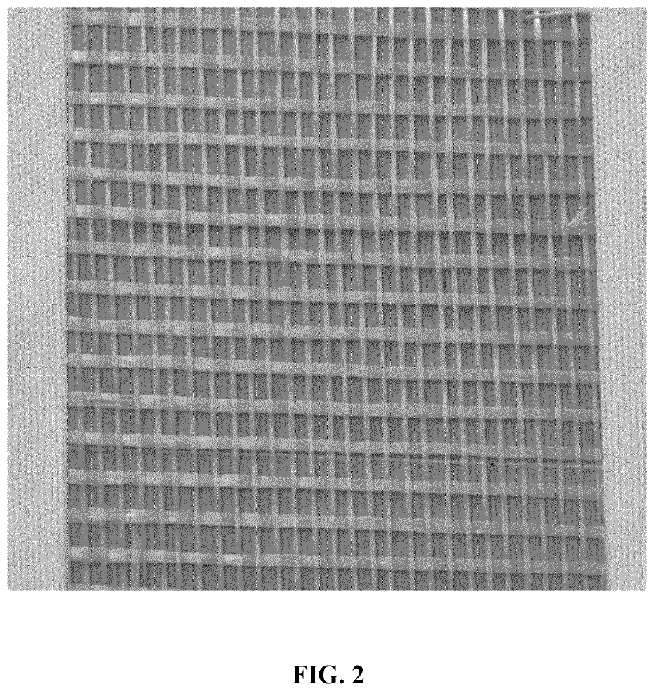

Glass fibers were used to form a fiber bundle, and the structure shown in FIG. 2 was formed by weaving the fiber bundles to cross each other to form a mesh structure.

### Example 1

A conductive layer was formed on a surface of the preparation example using graphite, and a cell was configured using the conductive layer as a working electrode and lithium metal as a counter electrode to form a lithium layer on a surface of the working electrode.

### Example 2

The surface of the preparation example was coated with silver nanowires (AgNWs), and a conductive layer was formed on the surface using silver (Ag) to be used as a working electrode; and black powder separated from a lithium secondary battery was used as a counter electrode to form a lithium layer on a surface of the working electrode.

### Example 3

All processes were performed in the same manner as in Example 1, except that silver (Ag) was deposited on the surface of the preparation example to form a conductive layer.

FIG. 2 shows a photograph of the structure prepared according to the present invention. The structure is composed of glass fibers, and the structure itself exhibits insulating properties with no electrical or electronic conductivity.

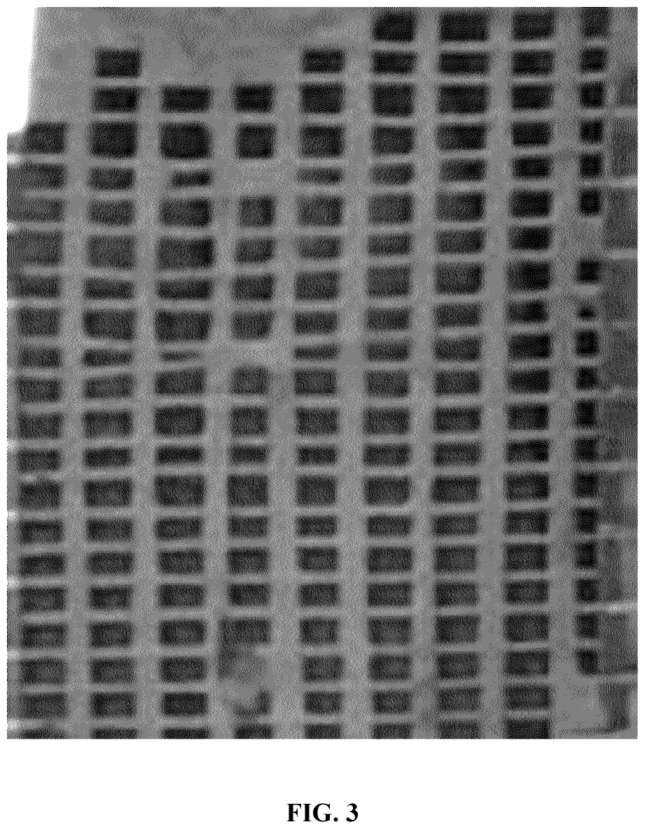

FIG. 3 shows a photograph of the structure on which a conductive layer formed of graphite is formed.

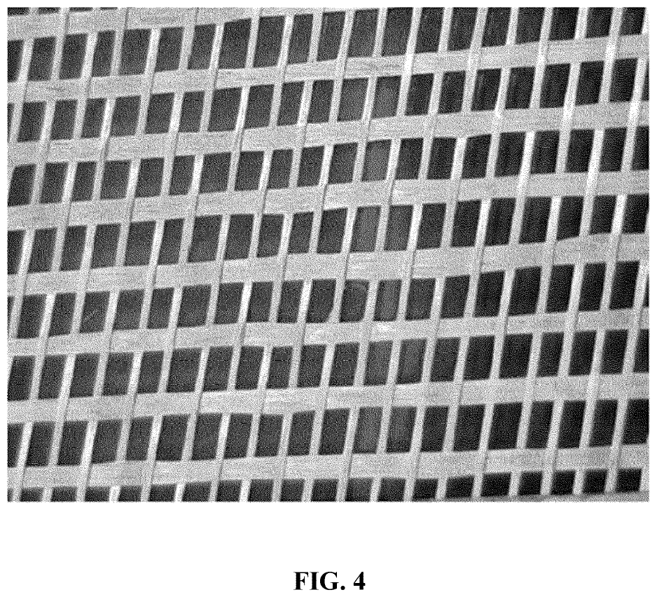

FIG. 4 shows a photograph of Example 2 in which a silver (Ag) conductive layer is formed.

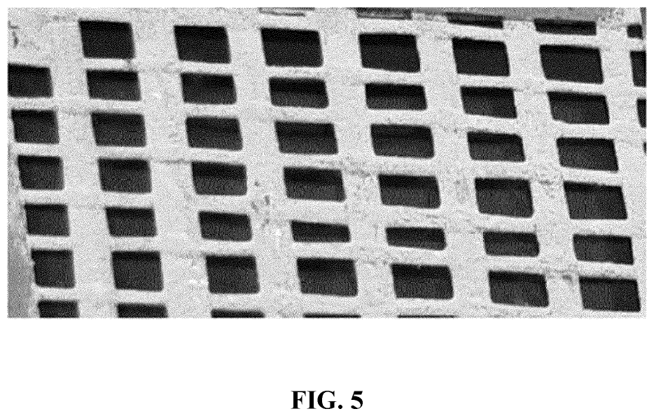

FIG. 5 shows a photograph of Example 3 in which a silver (Ag) conductive layer is formed.

As such, a lithium electrode characterized as a mesh-type structure can be manufactured only by forming a conductive layer on the surface of the structure using materials such as graphite or silver (Ag) to impart electrical or electronic conductivity. However, while excessive coating of the conductive layer may result in relatively excellent conductivity, it can lead to non-uniform coating formation, which may cause issues such as dendrite formation over the long term.

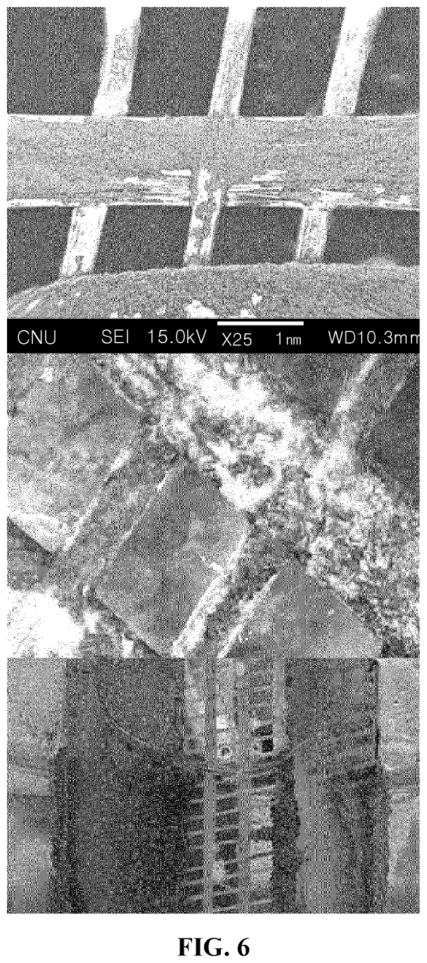

In FIG. 6, it can be confirmed that a large amount of dendrites and excess lithium are generated during the formation of the lithium layer in a beaker cell, and that these are precipitated in the form of scrap. As described above, the lithium precipitated in the form of scrap can be recycled as a counter electrode when manufacturing the lithium electrode of the present invention.

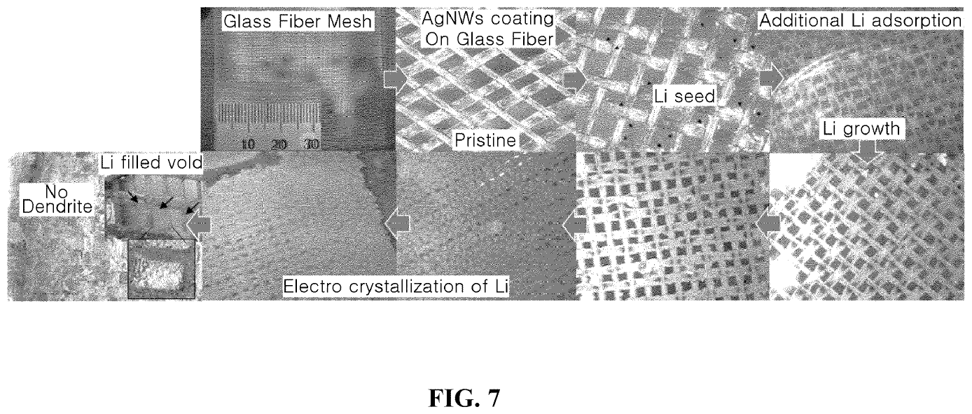

FIG. 7 shows the manufacturing process of Example 2. It can be confirmed that lithium seeds are formed and gradually grow on the silver nanowire conductive layer, and it can also be confirmed that no dendrites are formed during the formation of the lithium layer.

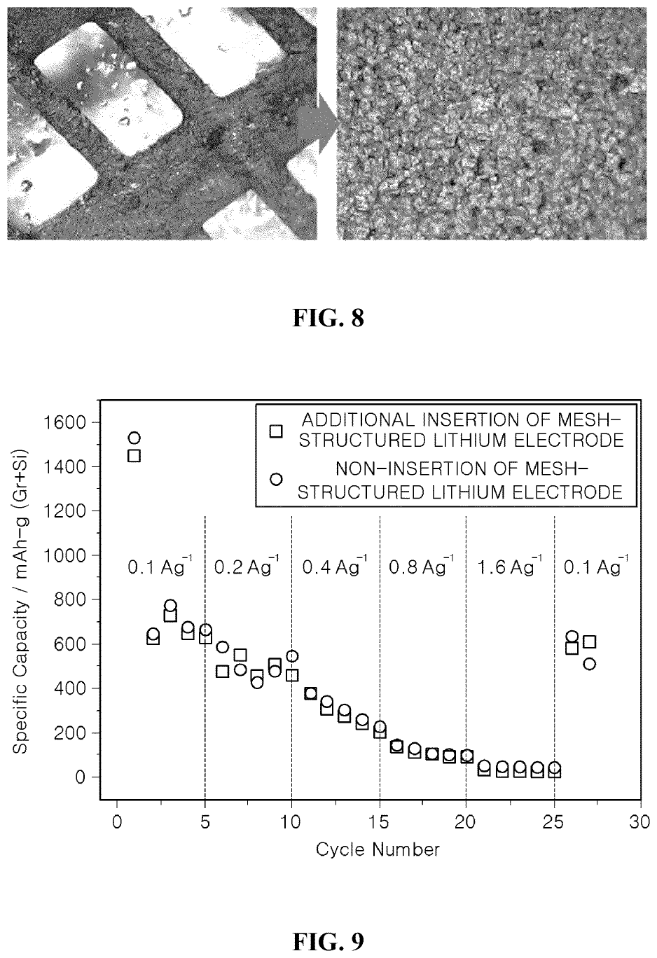

FIG. 8 shows an enlarged photograph of Example 2, in which the lithium layer is fully formed.

### Example 4

A CR2032 half-cell was manufactured using Example 2 and a negative electrode made of a negative electrode material, in which silicon particles with an average particle size of 50 nm and graphite particles with an average particle size of 13 μm were mixed, as a working electrode. 1.0M LiPF6 in EC/DMC (l:l, volume ratio) was used as an electrolyte, a polypropylene separator was used as a separator, and lithium foil was used as a counter electrode.

### Comparative Example

A CR2032 half-cell was manufactured using only a negative electrode made of a negative electrode material, in which silicon particles with an average particle size of 50 nm and graphite particles with an average particle size of 13 μm were mixed, as a working electrode.

FIG. 9 shows the specific capacities of Example 4 and the comparative example according to the C-rate (current density 0.1 to 1.6 A g⁻¹). The initial capacities were similar, ranging from approximately 1400 to 1600 mAh g⁻¹, and the specific capacities according to the subsequent C-rate changes were also similar.

That is, since Example 4 exhibited specific capacities nearly identical to those of the comparative example despite the addition of the lithium electrode according to the present invention, it can be confirmed that the lithium electrode possesses a specific capacity comparable to that of an electrode composed of silicon and graphite particles, and furthermore, the lithium electrode, as a structure, does not adversely affect the oxidation-reduction reactions of lithium ions.

While the present invention has been described with reference to specific details and limited embodiments as set forth above, these are provided only to facilitate a general understanding of the invention. The present invention is not limited to the above embodiments, and various modifications and variations may be made from these descriptions by those skilled in the art to which the present invention pertains.

Therefore, the spirit of the present invention should not be limited to the described embodiments, and all changes that fall within the scope of the following claims and their equivalents or equivalent variations shall be construed as falling within the scope of the spirit of the present invention.

1. A lithium electrode comprising:
a fiber bundle composed of a plurality of fibers;
a structure having a mesh form composed of the fiber bundle;
a conductive layer formed on the structure; and
a lithium layer formed on the conductive layer,
wherein openings, which are empty spaces between the fiber bundles constituting the structure, are formed at a density of 10 to 1,000/inch².

2. The lithium electrode of claim 1, wherein the fiber is glass fiber.

3. The lithium electrode of claim 1, wherein a shape of the opening is circular or polygonal.

4. The lithium electrode of claim 1, wherein the conductive layer is composed of any one or a mixture of two or more selected from the group consisting of metal materials such as silver (Ag), tin (Sn), copper (Cu), and stainless steel (SUS); or the group consisting of carbon materials such as carbon-based conductive materials, graphite, graphene, and carbon nanotubes (CNTs).

5. The lithium electrode of claim 1, wherein the conductive layer is in a form that surrounds the structure.

6. The lithium electrode of claim 1, wherein the lithium layer is in a form that surrounds the conductive layer.

7. The lithium electrode of claim 1, wherein a sum of thicknesses of the conductive layer and the lithium layer ranges from 5 to 120 μm.

8. A method of manufacturing the lithium electrode of claim 1, comprising:
a step (A) of forming a fiber bundle using a plurality of fibers;
a step (B) of forming a structure using the fiber bundle;
a step (C) of forming a conductive layer on a surface of the structure; and
a step (D) of forming a lithium layer on a surface of the conductive layer.

9. The method of claim 8, wherein the lithium layer in the step (D) is electrochemically formed on the surface of the conductive layer.

10. A lithium secondary battery comprising the lithium electrode of claim 1.

11. The lithium secondary battery of claim 10, comprising one or more solid electrolytes selected from LSPS(Li₁₀SnP₂S₁₂), LGPS(Li₁₀GeP₂S₁₂), and LPSCl(Li₆PS₅Cl).

12. The lithium secondary battery of claim 10, comprising a composite of the lithium electrode and a solid electrolyte.

13. The lithium secondary battery of claim 10, comprising any one selected from LCO (LiCoO₂), NCM (LiNiₓCo_{y}Mn_{z}O₂, x+y+z=1), LFP (LiFePO₄), and lithium polysulfide (Li₂Sₓ, 0<x≤9) as a positive electrode.
